(19) United States
(12) Patent Application Publication
(10) Pub. No.: US 2013/0302663 A1
(43) Pub. Date: Nov. 14, 2013

(54) ASSEMBLED BATTERY

(71) Applicant: Kabushiki Kaisha Toshiba, Tokyo (JP)

(72) Inventors: Ryuuichi TERAMOTO, Yokohama-shi (JP); Noboru Koike, Saku-shi (JP); Yasuyuki Nagase, Kashiwazaki-shi (JP); Hideo Shimizu, Saku-shi (JP); Takashi Murai, Saku-shi (JP); Takahiro Terada, Yokohama-shi (JP)

(73) Assignee: Kabushiki Kaisha Toshba, Tokyo (JP)

(21) Appl. No.: 13/838,908

(22) Filed: Mar. 15, 2013

(30) Foreign Application Priority Data
Mar. 23, 2012 (JP) 2012-066959

(51) Int. Cl. H01M 2/20

(52) U.S. Cl. CPC H01M 2/202; H01M 2/204; H01M 2/206
USPC 429/160

(57) ABSTRACT

According to one embodiment provides an assembled battery which comprises electric cells each having a protruding electrode terminal, a bus bar which is connected to the electrode terminal, also electrically connected to the electrode terminal, and comprises an accommodating portion that has an opening and accommodates the electrode terminal along a protruding direction of the protruding portion from the opening, and a protruding portion which is formed on one of a peripheral surface of the electrode terminal along the protruding direction and an inner surface of the accommodating portion along the protruding direction, protrudes toward the other of the peripheral surface and the inner surface, extends in the protruding direction, and comes into contact with the other.

### CROSS-REFERENCE TO RELATED APPLICATIONS

This application is based upon and claims the benefit of priority from Japanese Patent Application No. 2012-066959, filed Mar. 23, 2012, the entire contents of which are incorporated herein by reference.

### FIELD

Embodiments described herein relate generally to an assembled battery comprising electric cells.

### BACKGROUND

In an assembled battery comprising electric cells, a bus bar formed of a conductive member has been conventionally used to connect electrode terminals of the electric cells with each other. The electrode terminals are inserted into holes formed in the bus bar. To stabilize a contact state of the bus bar and the electrode terminals, a claw portion is provided on an edge of each hole of the bus bar. When each electrode terminal is inserted into each hole, the claw portion is swaged with respect to a peripheral surface of the electrode terminal. As a result, the contact state of the bus bar and the electrode terminals is stabilized.

### BRIEF DESCRIPTION OF THE DRAWINGS

FIG. 1 is a perspective view showing an assembled battery according to a first embodiment;

FIG. 2 is a perspective view showing a state that a bus bar in the assembled battery is disassembled with respect to electric cells in a range F2 depicted in FIG. 2;

FIG. 3 is a perspective view showing the bus bar;

FIG. 4 is a perspective view showing a terminal bus bar in the assembled battery;

FIG. 5 is a cross-sectional view of an accommodating portion of the bus bar, which shows a state that a fitting protruding portion of an electrode terminal of the electric cell is accommodated in the accommodating portion of the bus bar, taken along a direction vertical to a protruding direction of the accommodating portion;

FIG. 6 is a cross-sectional view of the accommodating portion before the fitting protruding portion is accommodated taken along the direction vertical to the protruding direction of the accommodating portion;

FIG. 7 is a cross-sectional view showing the fitting protruding direction taken along the protruding direction;

FIG. 8 is a cross-sectional view, which shows a state before the fitting protruding portion is completely accommodated in the accommodating portion, taken along the protruding direction;

FIG. 9 is a partially cutaway perspective view showing a state that the fitting protruding portion is pulled out from the accommodating portion depicted in FIG. 8;

FIG. 10 is a perspective view showing the fitting protruding portion in a state that the entire fitting protruding portion is accommodated in the accommodating portion and then the bus bar and the terminal bus bar are removed from the electrode terminals;

FIG. 11 is a cross-sectional view, which shows a state that a fitting protruding portion of a bus bar or a terminal bus bar in an assembled battery according to a second embodiment is accommodated in an accommodating portion, taken along a direction vertical to a protruding direction;

FIG. 12 is a cross-sectional view, which shows a state that a fitting protruding portion of a bus bar or a terminal bus bar in an assembled battery according to a third embodiment is accommodated in an accommodating portion, taken along a direction vertical to a protruding direction;

FIG. 13 is a perspective view showing a fitting protruding portion of a bus bar or a terminal bus bar in an assembled battery according to a fourth embodiment;

FIG. 14 is a cross-sectional view, which shows a state that the fitting protruding portion is accommodated in accommodating portions of the bus bar or the terminal bus bar, taken along a direction vertical to a protruding direction;

FIG. 15 is a cross-sectional view, which shows a state that the fitting protruding portion is accommodated in the accommodating portion of the bus bar or the terminal bus bar, taken along the direction vertical to the protruding direction in another example according to the fourth embodiment;

FIG. 16 is a cross-sectional view, which shows a state that the fitting protruding portion is accommodated in the accommodating portion of the bus bar or the terminal bus bar, taken along a direction vertical to the protruding direction; and

FIG. 17 is an enlarged perspective view showing an accommodating portion having a fitting accommodating portion accommodated therein in an assembled battery according to a fifth embodiment.

### DETAILED DESCRIPTION

In general, according to one embodiment provides an assembled battery. This assembled battery comprises: electric cells each having a protruding electrode terminal; a bus bar which is connected to the electrode terminal, also electrically connected to the electrode terminal, and comprises an accommodating portion that has an opening and accommodates the electrode terminal along a protruding direction of the protruding portion from the opening; and a protruding portion which is formed on one of a peripheral surface of the electrode terminal along the protruding direction and an inner surface of the accommodating portion along the protruding direction, protrudes toward the other of the peripheral surface and the inner surface, extends in the protruding direction, and comes into contact with the other.

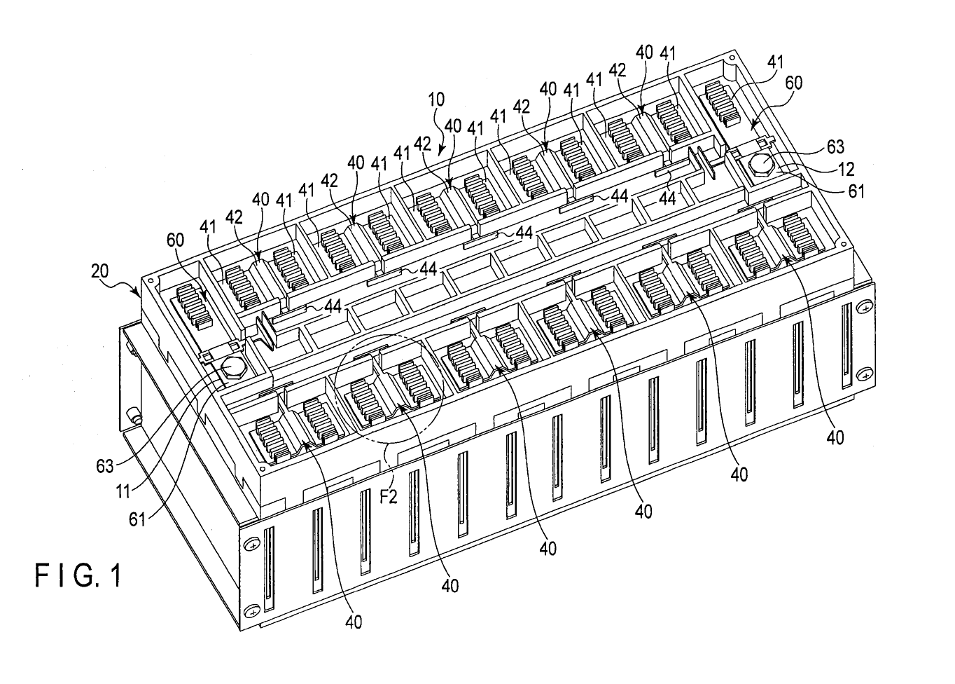

The assembled battery according to a first embodiment will now be described with reference to FIGS. 1 to 10. FIG. 1 is a perspective view showing an assembled battery 10. As shown in FIG. 1, the assembled battery 10 comprises a case 20, electric cells 30 accommodated in the case 20, bus bars 40 each of which is formed of a conductive member, and terminal bus bars 60 each of which is formed of a conductive member. In this embodiment, for example, the assembled battery 10 has the electric cells 30 electrically connected in series through the bus bars 40. In the electric cells 30 connected in series, the electric cells 30 arranged at both ends are electrically connected to external connection terminals 11 and 12 of the assembled battery 10 through the terminal bus bars 60.

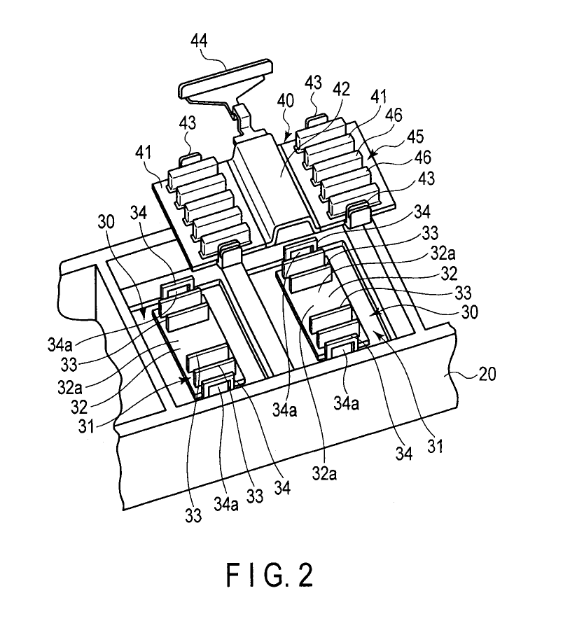

FIG. 2 shows a state that the bus bar 40 is disassembled with respect to the electric cells 30 in a range F2 depicted in FIG. 1. As shown in FIG. 2, the electric cells 30 comprise terminals for each of a positive electrode and a negative electrode, i.e., a total of two electrode terminals 31. Both the electrode terminals 31 are the same.

The electrode terminal 31 comprises a base portion 32, fitting protruding portions 33 protruding from the base portion 32, and a pair of first engagement claw portions 34. The base portion 32 has a tabular shape, and its planar shape is a square. A front surface 32a of the base portion 32 is a flat surface.

For example, the four fitting protruding portions 33 are formed. The fitting protruding portions 33 all have the same shape. For example, each fitting protruding portion 33 has a substantially rectangular parallelepiped shape. Each fitting protruding portion 33 protrudes in a direction vertical to the front surface 32a of the base portion 32. The fitting protruding portion 33 will be described later in detail. Both the first engagement claw portions 34 are arranged to sandwich the four fitting protruding portions 33. The electrode terminals 31 are the same in all the electric cells 30. Each electrode terminal 31 is made of, e.g., an aluminum material.

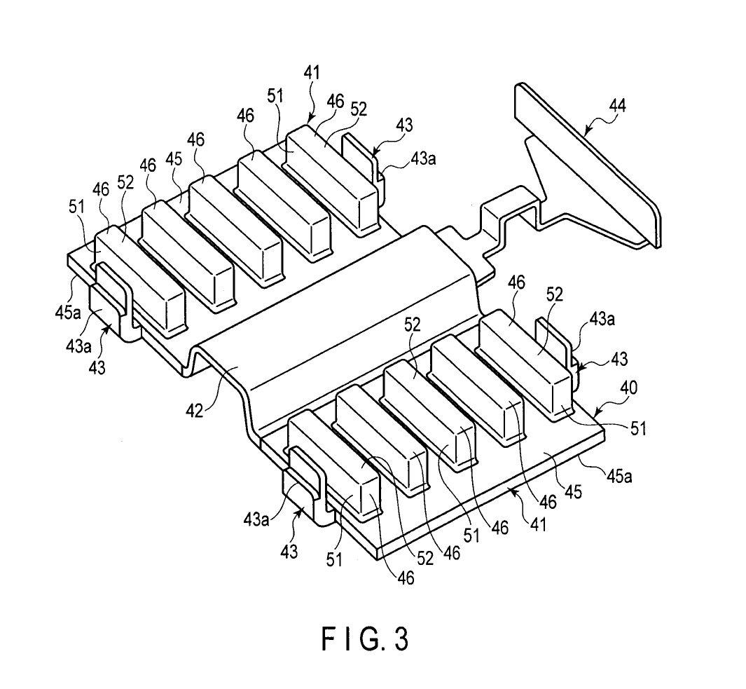

FIG. 3 is a perspective view showing the bus bar 40. As shown in FIG. 3, the bus bar 40 comprises a pair of fitting portions 41, a bend portion 42, second engagement claw portions 43, and a voltage detection terminal 44.

Both the fitting portions 41 have the same shape. Each fitting portion 41 comprises a base portion 45 and accommodating portions 46. The base portion 45 has a tabular shape with a square plane. The accommodating portions 46 accommodate the fitting protruding portions 33 of the electrode terminal 31. In this embodiment, since the four fitting protruding portions 33 are formed in one electrode terminal 31, five accommodating portions 46 are formed in one fitting portion 41. The respective accommodating portions 46 are fixed on the base portion 45, and hence the respective accommodating portions are integrally fixed to each other.

It is to be noted that, in this embodiment, the electrode terminal 31 comprises the four fitting protruding portions 33, and the bus bar 40 comprises the five accommodating portions 46. Therefore, one of the five accommodating portions 46 does not accommodate the fitting protruding portion 33. It is sufficient to provide the accommodating portions 46, which can cope with accommodation of all the fitting protruding portions 33 by the number thereof, on one fitting portion 41, and hence the four or more accommodating portions 46 can suffice in this embodiment. As an example that the number of the accommodating portions 46 is equal to or above the number of the fitting protruding portions 33, the five accommodating portions 46 are formed in this embodiment. The accommodating portions 46 will be specifically described later.

Both the second engagement claw portions 43 are arranged to sandwich the five accommodating portions 46. Each second engagement claw portion 43 has an engagement portion 43a. The engagement portion 43a protrudes to be away from the accommodating portions 46 along a direction that the respective accommodating portions 46 are aligned.

As shown in FIG. 2, each first engagement claw portion 34 has an engagement hole 34a. The engagement hole 34a is pierced in the first engagement claw portion 34. In a state that the fitting protruding portions 33 are accommodated in the accommodating portions 46, the engagement portions 43a of the second engagement claw portions 43 are fitted in the engagement holes 34a of the first engagement claw portions 34. As a result, the engagement portions 43a of the second engagement claw portions 43 engage with edge portions of the engagement holes 34a of the first engagement claw portions 34 in a direction along which the bus bar 40 is removed from each electrode terminal 31, i.e., a direction along which the fitting protruding portions 33 protrude, whereby the bus bar 40 is fixed to the electrode terminal 31 in the direction along which the bus bar 40 is removed from the electrode terminals 31.

It is to be noted that the first engagement claw portion 34 has elasticity. In the case of removing the bus bar 40 from each electrode terminal 31, the first engagement claw portions 34 are deformed in such a manner that the engagement portions 43a of the second engagement claw portions 43 are removed from the engagement holes 34a of the first engagement claw portions 34, i.e., that the engagement is canceled. Specifically, the first engagement claw portions 34 are warped to be away from the fitting protruding portions 33 along a direction that the fitting protruding portions 33 are aligned. As a result, since the engagement portions 43a of the second engagement claw portions 43 are disengaged from the edge portions of the engagement holes 34a of the first engagement claw portions 34, the bus bar 40 can be removed.

The bend portion 42 is coupled with edge portions, which are parallel to the alignment direction of the respective accommodating portions 46, of the base portions 45 of both the fitting portions 41, and it fixes both the fitting portions 41. The bend portion 42 has a shape that bends to protrude in a protruding direction of the accommodating portions 46. A thickness of the bend portion 42 is fixed.

In one bus bar 40, both the fitting portions 41 are electrically connected to each other through the bend portion 42. When the fitting protruding portions 33 of the electrode terminal 31 of either the positive electrode or the negative electrode of one electric cell 30 are accommodated in the accommodating portions 46 of one fitting portion 41, the electrode terminal 31 of this electric cell 30 is electrically connected to the bus bar 40. Further, when the fitting protruding portions 33 of the electrode terminal 31 of the other of the positive electrode and the negative electrode of an electric cell 30 different from the former electric cell 30 are accommodated in the accommodating portions 46 of the other fitting portion 41, the electrode terminal 31 of this different electric cell 30 is electrically connected to the bus bar 40. As a result, the one electric cell 30 and the different electric cell 30 are electrically connected in series through the bus bar 40.

The bent portion 42 protrudes in a direction vertical to an alignment direction of one pair of electric cells 30 electrically connected through the bus bar 40. It is to be noted that the alignment direction of the electric cells 30 is an alignment direction of the fitting portions 41. Therefore, in the case of connecting the bus bar 40 to the two electric cells 30, even if the electric cells 30 are displaced from each other, deformation of the bend portion 42 enables one fitting portion 41 to be connected to the electrode terminal 31 of one electric cell 30 and also enables the other fitting portion 41 to be connected to the electrode terminal 31 of the other electric cell 30. Furthermore, after the bus bar 40 is connected to the two electric cells 30, even if the one electric cell 30 and the other electric cell 30 are relatively displaced from each other, deformation of the bend portion 42 can absorb the relative displacement of the electric cells 30, and hence it is possible to suppress electrical connection between the electrode terminal 31 and the fitting portion 41, i.e., a positional relationship between the accommodating portions 46 and the fitting protruding portions 33 due to this displacement.

The voltage detection terminal 44 is coupled with the bend portion 42. The assembled battery 10 has a control unit that detects a voltage of each electric cell 30. The voltage detection terminal 44 is electrically connected to the control unit. When the voltage detection terminal 44 of each bus bar 40 is connected to the control unit, the control unit detects a voltage value of each electric cell 30 through each bus bar 40. The control unit detects a state of the assembled battery 10 based on the voltage value of each electric cell 30. The state of the assembled battery 10 is, e.g., a voltage value of the entire assembled battery 10.

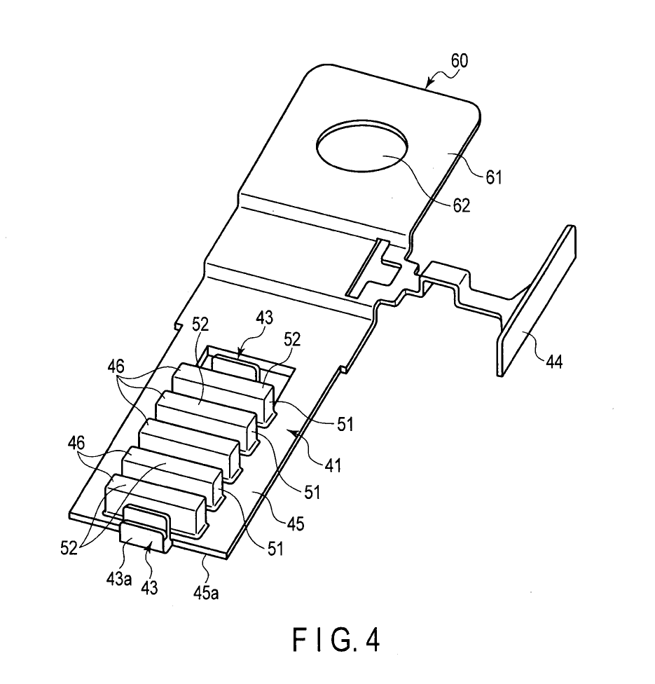

FIG. 4 is a perspective view showing the terminal bus bar 60. As shown in FIG. 4, the terminal bus bar 60 comprises an external terminal connecting portion 61 electrically connected to an external connection terminal 11 or 12 of the assembled battery 10, a fitting portion, and a voltage detection terminal. The external terminal connecting portion 61 is formed into a tabular shape and has a through hole 62. A screw hole is formed in each of the external connection terminals 11 and 12. In a state that the external terminal connecting portion 61 is in contact with the external connection terminal 11 or 12, a bolt 63 is screwed in the screw hole of the external connection terminal 11 or 12 via the through hole 62, whereby the external terminal connecting portion 61 is fastened with respect to the external connection terminal 11 or 12. As a result, the external terminal connecting portion 61 is electrically connected to the external connection terminal 11 or 12.

Since the voltage detection terminal and the fitting portion are equal to the voltage detection terminal 44 and the fitting portion 41 of the bus bar 40, respectively, the same reference numerals as the voltage detection terminal 44 and the fitting portion 41 of the bus bar 40 are provided, and a description will be omitted.

The external terminal connecting portion 61 is coupled with one end portion of the fitting portion 41 in the alignment direction of the accommodating portions 46. Moreover, the voltage detection terminal 44 is coupled with one side of each of the fitting portion 41 and the external terminal connecting portion 61 between these members.

It is to be noted that, as shown in FIG. 1, a pair of terminal bus bars 60 are used in the assembled battery 10 and the single voltage detection terminal 44 of each terminal bus bar 60 is provided on the inner side of the assembled battery 10 in regard to the terminal bus bars 60. That is, the position of the voltage detection terminal 44 of one terminal bus bar 60 is opposite to a position of the voltage detection terminal 44 of the other terminal bus bar 60.

Therefore, for example, each terminal bus bar 60 may originally have a pair of voltage detection terminals 44, and the voltage detection terminal 44 that is not required when the terminal bus bar 60 is assembled to the assembled battery 10 may be removed.

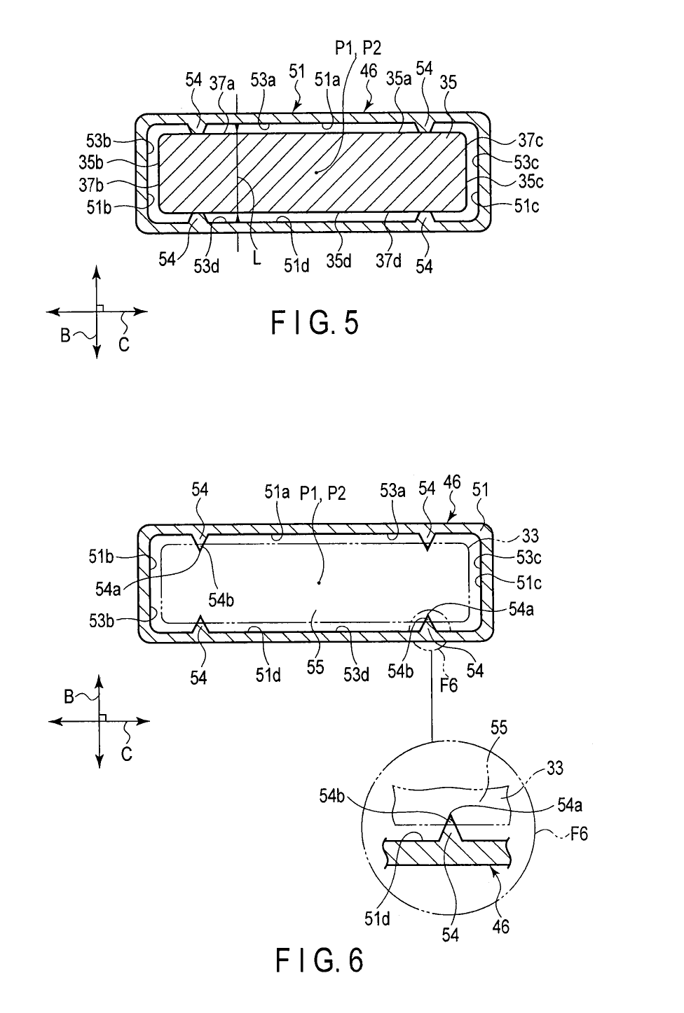

The accommodating portions 46 of the fitting portion 41 will now be described. First, a shape of each fitting protruding portion 33 will be specifically explained. FIG. 5 is a cross-sectional view of the accommodating portion 46 taken along a direction vertical to a protruding direction of the accommodating portion 46 in a state that the bus bar 40 is fixed to a pair of electric cells 30 in the electric cells 30, i.e., a state that each fitting protruding portion 33 is accommodated in each accommodating portion 46.

As shown in FIGS. 3 and 5, each accommodating portion 46 has a peripheral wall portion 51 and an end wall portion 52. The peripheral wall portion 51 has an annular shape that makes a circuit of the fitting protruding portion 33 in the protruding direction. The end wall portion 52 is coupled with a top end of the peripheral wall portion 51 and faces an end of the fitting protruding portion 33. The fitting protruding portion 33 is pushed into the accommodating portion 46 until the front surface 32a of the base portion 32 of the electrode terminal 31 comes into contact with a lower surface 45a of the base portion 45 of the fitting portion 41. It is to be noted that the lower surface 45a of the base portion 45 of the fitting portion 41 is a flat surface, and hence the front surface 32a and the lower surface 45a are subjected to surface contact. The entire fitting protruding portion 33 is accommodated in the accommodating portion 46.

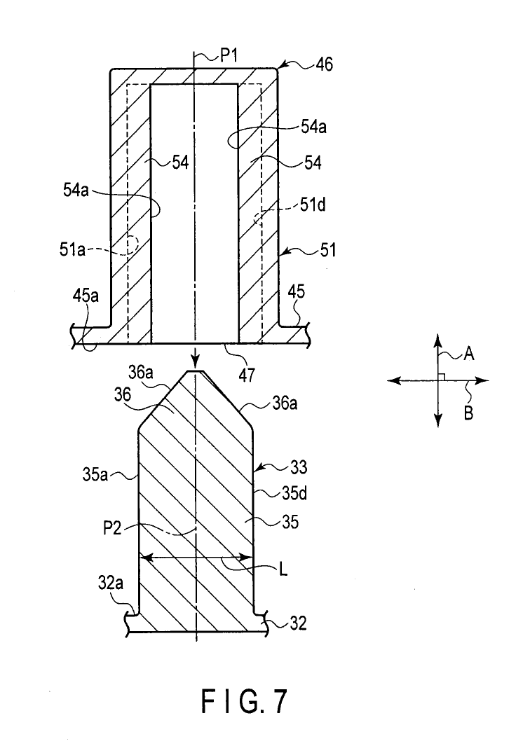

As shown in FIG. 2, the fitting protruding portion 33 has a substantially rectangular parallelepiped shape. FIG. 7 is a cross-sectional view showing a state that the fitting protruding portion 33 is cut along a protruding direction A. As shown in FIG. 7, the fitting protruding portion 33 has a main body portion 35 and an end portion 36. The end portion 36 is placed at an end of the main body portion 35.

A shape of a cross section of the main body portion 35 vertical to the protruding direction A is the same at any position in the protruding direction A. The main body portion 35 includes first to fourth peripheral surfaces 35a to 35d. The first and fourth peripheral surfaces 35a and 35d are flat surfaces parallel to the protruding direction A, and they are parallel to each other. The second and third peripheral surfaces 35b and 35c are flat surfaces parallel to the protruding direction A, and they are parallel to each other. The first and second peripheral surfaces 35a and 35b are orthogonal to each other.

It is to be noted that FIG. 5 shows the fitting protruding portion 33 taken along a direction vertical to a direction extending from the first peripheral surface 35a to the fourth peripheral surface 35d, i.e., an extending direction of each of the second and third peripheral surfaces 35b and 35c.

Here, a width direction B and a depth direction C are defined. The width direction B is a direction vertical to the protruding direction A and parallel to the second and third peripheral surfaces 35b and 35c of the main body portion. The depth direction C is a direction vertical to the protruding direction A and the width direction B. A width L parallel to the width direction B of the main body portion 35 is the same at any position in the protruding direction A. The end portion 36 is formed into a shape whose width in the width direction B is gradually narrowed toward the end.

FIG. 5 is a cross-sectional view running through the main body portion 35 of the fitting protruding portion 33. In the main body portion 35 of the fitting protruding portion 33, a shape of a cross section vertical to the protruding direction A is the same as that in FIG. 5 at any position in the protruding direction A. Additionally, a cross-sectional shape of the fitting protruding portion 33 in the protruding direction A is the same as that in FIG. 7 at any position in the depth direction C.

As shown in FIG. 5, the peripheral wall portion 51 of the accommodating portion 46 has a shape surrounding the fitting protruding portion 33. An inner surface of the peripheral wall portion 51 has first to fourth inner surfaces 51a, 51b, 51c, and 51d. The first inner surface 51a is a flat surface that faces the first peripheral surface 35a of the main body portion 35 of the fitting protruding portion 33. The second inner surface 51b is a flat surface that faces the second peripheral surface 35b of the main body portion 35. The third inner surface 51c is a flat surface that faces the third peripheral surface 35c of the main body portion 35. The fourth inner surface 51d is a flat surface that faces the fourth peripheral surface 35d of the main body portion 35. The first and fourth inner surfaces 51a and 51d are arranged to face each other, and they are parallel to each other. The second and third inner surfaces 51b and 51c are arranged to face each other, and they are parallel to each other. The first and second inner surfaces 51a and 51b are vertical to each other. In a state that each fitting protruding portion 33 is accommodated in each accommodating portion 46 and the front surface 32a of the base portion 32 and the lower surface 45a of the base portion 45 of the fitting portion 41 are subjected to surface contact, the first to fourth inner surfaces 51a to 51d are parallel to the protruding direction A.

Here, as shown in FIG. 5, edges of a cross section formed by cutting the first to fourth peripheral surfaces 35a to 35b in a direction vertical to the protruding direction A are determined as first to fourth edges 37a, 37b, 37c, and 37d, respectively. The first edge 37a is an edge formed by cutting the first peripheral surface 35a. The second edge 37b is an edge formed by cutting the second peripheral surface 35b. The third edge 37c is an edge formed by cutting the third peripheral surface 35c. The fourth edge 37d is an edge formed by cutting the fourth peripheral surface 35d.

As shown in FIG. 5, the first and fourth edges 37a and 37d are longer than the second and third edges 37b and 37c. Therefore, in regard to first to fourth edges 53a, 53b, 53c, and 53d formed by cutting the first to fourth inner surfaces 51a to 51d in a direction vertical to the protruding direction A, the first and fourth edges 53a and 53d are longer than the second and third edges 53b and 53c.

Connection protruding portions 54 are formed on the peripheral wall portion 51 of the accommodating portion 46. The two connection protruding portions 54 are arranged on each of the first and fourth inner surfaces 51a and 51d of the accommodating portion 46. The connection protruding portions 54 protrude toward the inner side beyond the first and fourth inner surfaces 51a and 51d. One of the two connection protruding portions 54 arranged on the first inner surface 51a is arranged on the second inner surface 51b side of the first inner surface 51a. The other is arranged on the third inner surface 51c side of the first inner surface 51a. One of the two connection protruding portions 54 arranged on the fourth inner surface 51d is arranged on the third inner surface 51c side. The other is arranged on the fourth inner surface 51b side of the first inner surface 51a.

Further, one of the two connection protruding portions 54 arranged on the first inner surface 51a faces one of the two connection protruding portions 54 arranged on the fourth inner surface 51d along the width direction B. The other connection protruding portion 54 arranged on the first inner surface 51a faces the other connection protruding portion 54 on the fourth inner surface 51d in the width direction B.

A position of each connection protruding portion 54 for the first inner surface 51a is equal to a position of each connection protruding portion 54 for the fourth inner surface 51d. In other words, even if the accommodating portion 46 is rotated 180 degrees on a center line P1, namely, even if the cross section shown in FIG. 5 is rotated 180 degrees on the center line P1, the shape of the cross section is the same. That is, a distance from the second inner surface 51b to the connection protruding portion 54 arranged on the second inner surface 51b side of the first inner surface 51a is equal to a distance from the same to the connection protruding portion 54 arranged on the second inner surface 51b side of the fourth inner surface 51d. A distance from the third inner surface 51c to the connection protruding portion 54 arranged on the third inner surface 51c side of the first inner surface 51a is equal to a distance from the same to the connection protruding portion 54 arranged on the third inner surface 51c side of the fourth inner surface 51d. Furthermore, a distance from the second inner surface 51b to the connection protruding portion 54 arranged on the second inner surface 51b side of the first or fourth inner surface 51a or 51d is equal to a distance from the third inner surface 51c to the connection protruding portion 54 arranged on the third inner surface 51c side on the first or fourth inner surface 51a or 51d.

The center line P1 is a line running through the center of the inner space defined by the first to fourth inner surfaces 51a to 51d when the accommodating portion 46 is cut in a direction vertical to the protruding direction of the accommodating portion. The protruding direction of the accommodating portion 46 is parallel to the protruding direction A when the fitting protruding portions 33 are accommodated in the accommodating portions 46.

As shown in FIG. 7, each connection protruding portion 54 extends to the end wall portion 52 from the edge of the opening 47 of the accommodating portion 46 on each of the first and fourth inner surfaces 51a and 51d. Here, the four connection protruding portions 54 all have the same shape.

FIG. 6 is a cross-sectional view showing a state that the accommodating portion 46 before accommodating the fitting protruding portions 33 is cut in the direction vertical to the protruding direction of the accommodating portion 46. FIG. 6 shows a state that the accommodating portion 46 is cut at the same position as that in FIG. 5. That is, the drawing shows a cross section of a region where the main body portion 35 of each fitting protruding portion 33 is placed.

In FIG. 6, the fitting accommodating portion 33 accommodated in the accommodating portion 46 is indicated by a dashed line of one long dash and two short dashes. FIG. 6 shows the fitting protruding portion 33 indicated by the dashed line in FIG. 6, which is a range 55 where the fitting protruding portion 33 is placed in the accommodating portion 46. A range F6 in FIG. 6 shows the connection protruding portion 54 and its vicinity in an enlarged manner. As shown in the range F6, the connection protruding portion 54 has a triangular cross-sectional shape. Each fitting protruding portion 33 is formed in such a manner that both the protruding ends 54a are placed on the inner side of the main body portion 35 of the fitting protruding portion 33.

Specifically, the end portion of each connection protruding portion 54 formed in the inner surface 51a is placed on the inner side beyond the first peripheral surface 35a, and the end portion of each connection protruding portion 54 formed on the fourth inner surface 51d is placed on the inner side beyond the fourth peripheral surface 35d.

Each connection protruding portion 54 is made of a material softer than each fitting protruding portion 33. In this embodiment, the bus bars 40 and the terminal bus bar 60 are made of a material softer than the electrode terminals 31, and hence the connection protruding portions 54 are softer than the fitting protruding portions 33. When the connection protruding portions 54 are made of a material softer than the fitting protruding portions 33, the connection protruding portion 54 are easily scraped as compared with the fitting protruding portions 33.

As shown in FIG. 6, the protruding end 54a of each connection protruding portion 54 has a size that enables itself to be placed on the inner side of each of the first and fourth peripheral surfaces 35a and 35d of the main body 35 of each fitting protruding portion 33, and each connection protruding portion 54 is made of a material softer than each fitting protruding portion 33. Therefore, when each fitting protruding portion 33 is inserted into the accommodating portion 46 through the opening 47 to accommodate the fitting protruding portion 33, the protruding end portion 54b of each connection protruding portion 54 comes into contact with each of the first and fourth peripheral surfaces 35a and 35b of the fitting protruding portion 33, and hence it is scraped.

A description will now be given as to deformation of the connection protruding portion 54 at the time of inserting the fitting protruding portion 33 from the opening portion 47 to accommodate the fitting protruding portion 33 in the accommodating portion 46. FIG. 7 shows a state immediately before the fitting protruding portion 33 is inserted into the accommodating portion 46. As shown in FIG. 7, the end portion 36 of the fitting protruding portion 33 is arranged to face the opening 47 of the accommodating portion 46. In this state, to insert the fitting protruding portion 33 into the accommodating portion 46, the bus bar 40 or the terminal bus bar 60 is moved closer to the electrode terminal 31.

The end portion 36 of the fitting protruding portion 33 has a shape whose width in the width direction B is narrowed toward the end. Therefore, the peripheral surface of the end portion 36 does not come into contact with the connection protruding portion 54. It is to be noted that, when the center line P1 of the accommodating portion 46 deviates from a center line P2 of the fitting protruding portion 3 as seen in the protruding direction A, the peripheral surface 36a of the end portion 36 is brought into contact with the connection protruding portion 54. The center line P2 is a line running through the center of the cross section when the fitting protruding portion 33 is cut in the direction vertical to the protruding direction A.

The peripheral surface 36a of the end portion 36 is inclined in the protruding direction A. Therefore, the peripheral surface 36a of the end portion 36 is brought into contact with the connection protruding portion 54. Furthermore, in a state that the peripheral surface 36a of the end portion 36 is in contact with the protruding end 54a of each connection protruding portion 54, when the bus bar 40 and the terminal bus bar 60 are moved closer to the electrode terminal 31 side to accommodate each fitting protruding portion 33 in each accommodating portion 46, the peripheral surface 36a of the end portion 36 serves as a guide surface, and positions of the bus bar 40 and the terminal bus bar 60 are adjusted in such a manner that the center line P1 of the accommodating portion 46 and the center line P2 of the fitting protruding portion 33 overlap in the protruding direction A. As a result, when the main body portion 35 of the fitting protruding portion 33 is accommodated in the accommodating portion 46, as shown in FIG. 5, the center line P1 of the fitting protruding portion 33 and the center line P2 of the accommodating portion 46 overlap in the protruding direction A.

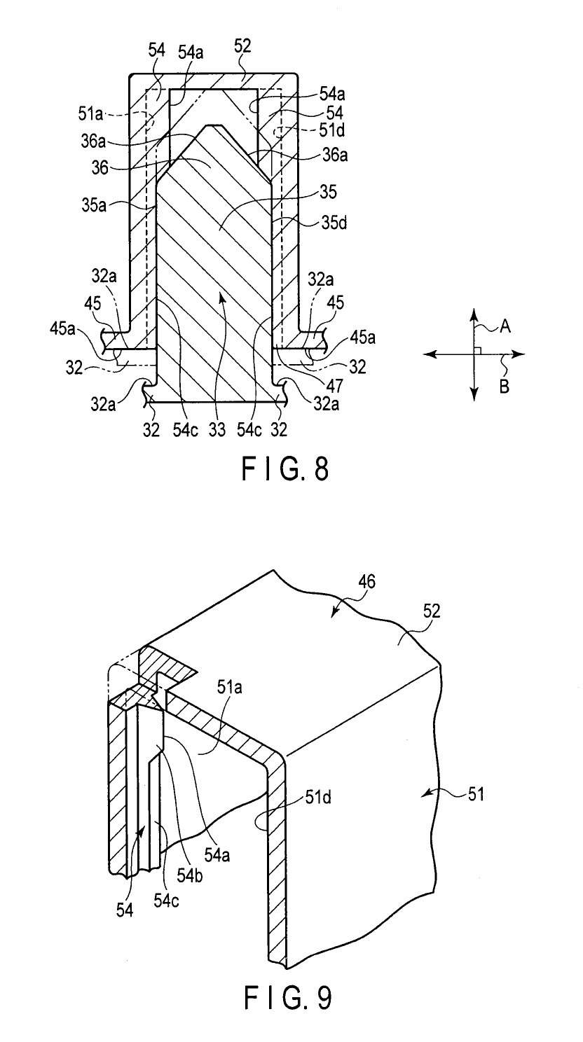

FIG. 8 is a cross-sectional view, which shows a state before the fitting protruding portion 33 is completely accommodated in the accommodating portion 46, taken along the protruding direction A. It is to be noted that “being completely accommodated” means being accommodated until the front surface 32a of the base portion 32 is brought into surface contact with the lower surface 45a of the base portion 45. As described above, the protruding end 54a of each connection protruding portion 54 has a size that enables the protruding end 54a to be placed on the inner side beyond the first or fourth peripheral surface 35a or 35d of the main body portion 35. Therefore, when the main body portion 35 is accommodated in the accommodating portion 46, each connection protruding portion 54 comes into contact with the first or fourth peripheral surface 35a or 35d of the fitting protruding portion 33, thereby scraping the protruding end portion 54b. FIG. 9 is a partially cutaway perspective view showing a situation where the fitting protruding portion 33 is pulled out from the accommodating portion 46 in the state depicted in FIG. 8. As shown in FIG. 9, the protruding end portion 54b of the connection protruding portion 54 is scraped when it is rubbed against the first or fourth peripheral surface 35a or 35d of the fitting protruding portion 33. A scraped surface is denoted by reference numeral 54c.

Each of the bus bar 40 and the terminal bus bar 60 is pushed in toward the electrode terminal 31 side until the front surface 32a of the base portion 32 of the electrode terminal 31 is brought into surface contact with the lower surface 45a of the base portion 45 of the fitting portion 41. In FIG. 8, the electrode terminal 31 accommodated in the accommodating portion 46 until the front surface 32a of the base portion 32 of the electrode terminal 31 is brought into surface contact with the lower surface 45a of the base portion 45 of the fitting portion 41 is indicated by a dashed line of one long dash and two short dashes. As indicated by the dashed line in FIG. 8, the entire fitting protruding portion 33 is accommodated in the accommodating portion 46.

It is to be noted that, as shown in FIG. 8, in the state that the front surface 32a of the base portion 32 of the electrode terminal 31 is in contact with the lower surface 45a of the base portion 45 of the fitting portion 41, the end of the end portion 36 of the fitting protruding portion 33 is in contact with the inner surface of the end wall portion 52 of the accommodating portion 46. As another example, the end of the end portion 36 does not have to be in contact with the inner surface of the end wall portion 52.

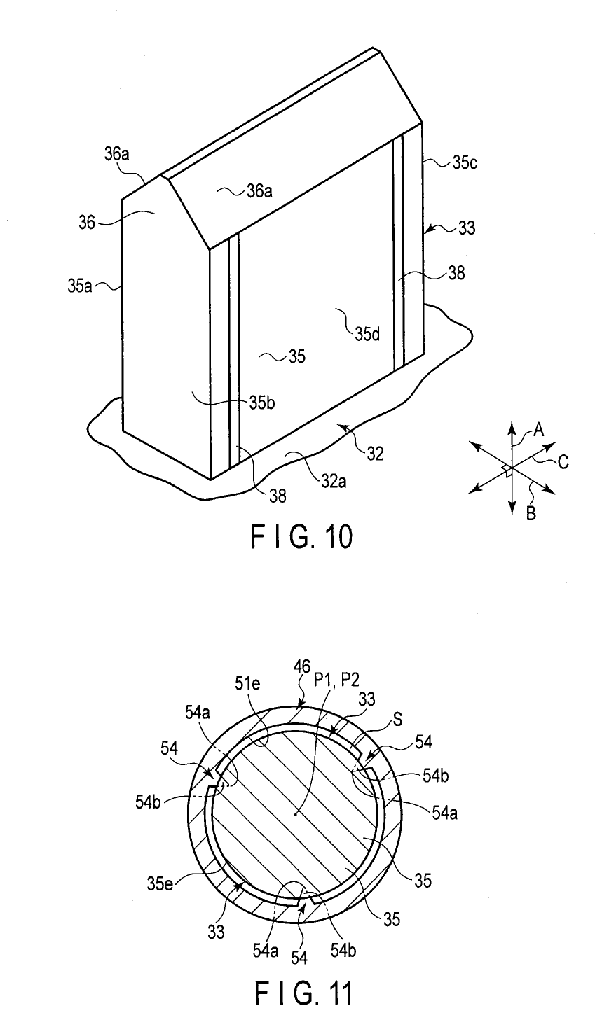

The connection protruding portion 54 extends from the opening 47 to the inner surface of the end wall portion 52 on the first or fourth inner wall 51a or 51d. Moreover, the entire fitting protruding portion 33 is accommodated in the accommodating portion 46. Therefore, on the first or fourth peripheral surface 35a or 35d of the fitting protruding portion 33, a part that comes into contact with the connection protruding portion 54 and scrapes the end portion of the connection protruding portion 54 is formed from a distal end of the main body portion 35, i.e., a boundary between the main body portion 35 and the end portion 36 to a proximal end. FIG. 10 is a perspective view showing the fitting protruding portion 33 in a state that the entire fitting protruding portion 33 is accommodated in the accommodating portion 46 and then the bus bar 40 and the terminal bus bar 60 are removed from the electrode terminals 31. A surface of a scraped portion 38 is also scraped at the time of scraping the protruding end portion 54b of the connection protruding portion 54. It is to be noted that, since the connection protruding portion 54 is made of a material softer than the fitting protruding portion 33, a degree of scraping the scraped portion 38 is smaller than that of the connection protruding portion 54.

In the thus configured assembled battery 10, the connection protruding portion 54 has a size that allows the protruding end portion 54b to be present in the range where the fitting protruding portion 33 is arranged in the accommodating portion 46 before a state that the fitting protruding portion 33 is accommodated in the accommodating portion 46. Therefore, when the fitting protruding portion 33 is accommodated in the accommodating portion 46, the protruding end portion 54b of the connection protruding portion 54 comes into contact with the first or fourth peripheral surface 35a or 35d of the fitting protruding portion 33 and is rubbed against the first or fourth peripheral surface 35a or 35d, whereby it is scraped. Further, on the first or fourth peripheral surface 35a or 35d of the fitting protruding portion 33, although a degree of scraping of the scraped part 38 that is rubbed against the connection protruding portion 54 is smaller than that of the connection protruding portion 54, the part 38 is scraped.

In this manner, when the protruding end portion 54b of each connection protruding portion 54 and each scraped portion 38 on the first or fourth peripheral surface 35a or 35d are scraped, regions of each connection protruding portion 54 and each of the first and fourth peripheral surfaces 35a and 35d which have oxidized surface parts removed therefrom come into contact with each other.

Moreover, when each connection protruding portion 54 extends in the protruding direction A, the region of the first or fourth peripheral surface 35a or 35d of the fitting protruding portion 33 that comes into contact with the protruding end portion 54b of each of both the connection protruding portions 54, i.e., the scraped portion 38 is constantly rubbed against the protruding end portion 54b of the connection protruding portion 54. Therefore, the scraped portion 38 is flattened by the connection protruding portion 54. Likewise, the connection protruding portion 54 is flattened when it is rubbed against the scraped portion 38. Therefore, each range in which the connection protruding portion 54 actually comes into contact with the first or fourth peripheral surface 35a or 35d can be enlarged. This point will now be specifically explained.

Each of the first and fourth peripheral surface 35a and 35d is the flat surface as described above. However, when this surface is magnified, it is actually a rough surface. Therefore, even if the connection protruding portion 54 is brought into surface contact with the first or fourth peripheral surface 35a or 35d, a range in which these members are actually electrically connected is small.

However, in this embodiment, the surfaces of each connection protruding portion 54 and each of the first and fourth peripheral surfaces 35a and 35d which come into contact with each other are flattened. Therefore, in the surface-contact state, the range in which these members are actually electrically in contact is large.

Therefore, excellent electrical connection between the bus bar 40 or the terminal bus bar 60 and the electrode terminal 31 can be provided.

Additionally, when each of the first and fourth peripheral surfaces 35a and 35d of the fitting protruding portion 33 is parallel to the protruding direction A and each of the first and fourth inner surfaces 35a and 35d is set parallel to the protruding direction A at the time of accommodating each fitting protruding portion 33 in the accommodating portion 46, the state that the protruding end portion 54b of each connection protruding portion 54 is constantly in contact with each of the first and fourth inner surfaces 51a and 51d is maintained while the fitting protruding portion 33 is being pushed into the accommodating portion 46. As a result, the rubbing state of each fitting protruding portion 33 and each connection protruding portion 54 of the accommodating portion 46 can be maintained.

Further, a positional relationship of each connection protruding portion 54 with respect to the first inner surface 51a is equal to a positional relationship of each connection protruding portion 54 with respect to the fourth inner surface 51d. Furthermore, all the four connection protruding portions 54 can have the same shape. Moreover, the center line P1 of the fitting protruding portion 33 is accommodated in the accommodating portion 46 while overlapping the center line P2 of the accommodating portion 46 in the protruding direction A. Therefore, each fitting protruding portion 33 is held between the two connection protruding portions 54 arranged on the first inner surface 51a and the two connection protruding portions 54 arranged on the fourth inner surface 51d, and a pressing load of the two connection protruding portions 54 on the first inner surface 51a with respect to the fitting protruding portion 33 is equal to a pressing load of the two connection protruding portions 54 on the fourth inner surface 51d with respect to the fitting protruding portion 33.

Therefore, since both the connection protruding portions 54 are pressed against each of the first and fourth peripheral surfaces 35a and 35d of the fitting protruding portion 33 in a well-balanced manner, the excellent electrical connection state can be maintained.

Additionally, since each connection protruding portion 54 is formed on the bus bar 40 or the terminal bus bar 60, it is possible to suppress an increase in cost when the bus bar 40 or the terminal bus bar 60 is assembled to the electric cell 30, then the bus bar 40 or the terminal bus bar 60 is removed, and the bus bar 40 or the terminal bus bar 60 is again assembled.

This point will now be specifically explained. Each electrode terminal 31 is integrally fixed to the electric cell 30. In a case where each connection protruding portion 54 is formed on the electrode terminal 31, when the bus bar 40 or the terminal bus bar 60 is connected to the electrode terminal 31 and then the bus bar 40 or the terminal bus bar 60 is removed, the connection protruding portion 54 integrally formed on the fitting protruding portion 33 of the electrode terminal 31 is scraped. Subsequently, to assemble the bus bar 40 or the terminal bus bar 60 to the electrode terminal 31, when each connection protruding portion 54 is replaced, the entire electric cell 30 must be replaced.

However, since each connection protruding portion 54 is formed on the bus bar 40 or the terminal bus bar 60, when the bus bar 40 or the terminal bus bar 60 is assembled to the electrode terminal 31 and then the bus bar 40 or the terminal bus bar 60 is again assembled to the electric cell, preparing the new bus bar 40 or terminal bus bar 60 having non-scraped connection protruding portions 54 can suffice.

Therefore, since the new electric cell 30 does not have to be prepared, it is possible to suppress an increase in cost when the bus bar 40 or the terminal bus bar 60 is assembled to the electric cell 30, then the bus bar 40 or the terminal bus bar 60 is removed, and the bus bar 40 or the terminal bus bar 60 is again assembled.

An assembled battery according to a second embodiment will now be described with reference to FIG. 11. In this embodiment, reference numerals equal to those in the first embodiment denote structures having the same functions as those in the first embodiment, thereby omitting a description thereof. In this embodiment, a shape of a fitting protruding portion 33 is different from that in the first embodiment. Further, in accordance with the fitting protruding portion 33, a shape of an accommodating portion 46 is different from that in the first embodiment. Other points are the same as the first embodiment. The different points will be specifically explained.

FIG. 11 is a cross-sectional view taken along a direction vertical to a protruding direction A, which shows a state that a bus bar 40 or a terminal bus bar 60 is electrically connected to an electrode terminal 31, i.e., a state that the fitting protruding portion 33 is accommodated in the accommodating portion 46.

As shown in FIG. 11, in this embodiment, a main body portion 35 of the fitting protruding portion 33 is formed into a cylindrical shape having a circular cross section. An end portion is formed into a conical shape. Therefore, the main body portion 35 does not have the first to fourth peripheral surfaces 35a to 35d described in the first embodiment. A peripheral surface 35e of the main body portion 35 is parallel to a protruding direction A.

The accommodating portion 46 is formed into a cylindrical shape having a gap S formed between itself and the peripheral surface 35e of the main body portion 35. The gap S is a fixed gap. An inner surface 51e of the accommodating portion 46 is parallel to the protruding direction A in a state that the fitting protruding portion 33 is accommodated in the accommodating portion 46 and a front surface 32a of a base portion 32 is in surface contact with a lower surface 45a of a base portion 45.

Connection protruding portions 54 are arranged at equal intervals in a circumferential direction with respect to a center line P1 of the accommodating portion 46. In this embodiment, for example, they are arranged at intervals of 120 degrees around the center line P1. Even in this embodiment, the respective connection protruding portions 54 have the same shape. It is to be noted that each protruding end portion 54 to be scraped is indicated by the dashed line of one long dash and two short dashes in the drawing.

In this embodiment, the connection protruding portions 54 are apart from each other at equal intervals around the center line P1. In other words, they are arranged at intervals of the same angle. Therefore, the connection protruding portions 54 can hold the fitting protruding portion 33 in a well-balanced manner. Even this embodiment obtains the same functions and effects as the first embodiment.

Moreover, in the case of accommodating the fitting protruding portion 33 in the accommodating portion 46, when postures of a bus bar 40 and a terminal bus bar 60 are set in such a manner that the inner surface 51e of the accommodating portion 46 becomes parallel to the protruding direction A, a contact state of the protruding end portions 54b of the connection protruding portions 54 and the inner surface 35e can be maintained during the process of accommodating the fitting protruding portion 33 in the accommodating portion 46 like the first embodiment.

It is to be noted that, in this embodiment, the respective connection protruding portions 54 are formed at intervals of 120 degrees, and hence the three connection protruding portions 54 are formed. As another example, these portions may be formed at intervals of 45 degrees, 60 degrees, 90 degrees, or the like.

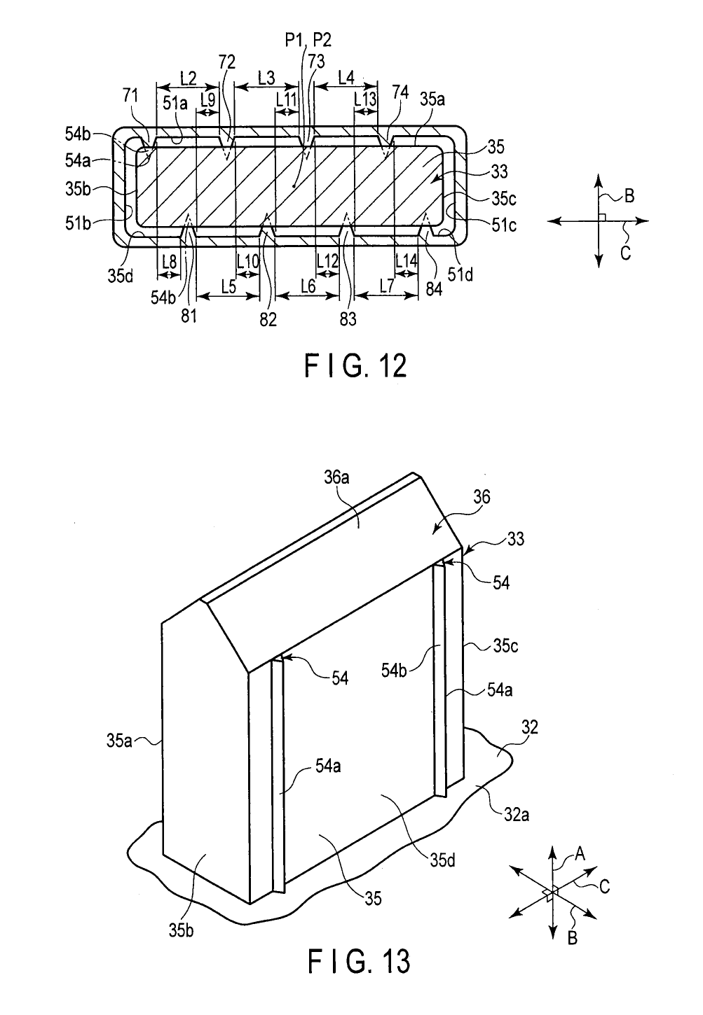

An assembled battery according to a third embodiment will now be described with reference to FIG. 12. In this embodiment, reference numerals equal to those in the first embodiment denote structures having the same functions as those in the first embodiment, and a description thereof will be omitted. In this embodiment, the number and arrangement of the connection protruding portions are different from those in the first embodiment. Other points are the same as the first embodiment. The different points will be specifically explained.

FIG. 12 shows a state that each bus bar 40 and each terminal bus bar 60 according to this embodiment are connected to electrode terminals 31, i.e., a state that each fitting protruding portion 33 is accommodated in each accommodating portion 46, which is taken along a direction vertical to a protruding direction A. As shown in FIG. 12, in this embodiment, connection protruding portions are formed on respective first and fourth inner surfaces 51a and 51d. A size and a shape of the connection protruding portion are the same as those of the connection protruding portion 54 according to the first embodiment.

The connection protruding portions, formed on the first peripheral surface 35a and the connection protruding portions formed on the fourth peripheral surface 35d are alternately arranged along a depth direction C. This point will be specifically explained. In this embodiment, for example, the connection protruding portions formed on the first peripheral surface 35a are determined as first to fourth connection protruding portions 71, 72, 73, and 74. The connection protruding portions formed on the fourth peripheral surface 35d are determined as fifth to eighth connection protruding portions 81, 82, 83, and 84.

The first connection protruding portion 71 is arranged at one end portion of the first inner surface 51a in the depth direction C. The fifth connection protruding portion 81 is arranged at a position which is closer to the other end from the one end along the depth direction C with respect to the first connection protruding portion 71, on the fourth inner surface 51d. The second connection protruding portion 72 is arranged at a position which is closer to the other end side with respect to the fifth connection protruding portion 81, on the first inner surface 51a. The sixth connection protruding portion 82 is arranged at a position which is closer to the other end side with respect to the second connection protruding portion 72, on the fourth inner surface 51d. The third connection protruding portion 73 is arranged at a position which is closer to the other end side with respect to the sixth connection protruding portion 82, on the first inner surface 51a. The seventh connection protruding portion 83 is arranged at a position which is closer to the other end side with respect to the third connection protruding portion 73, on the fourth inner surface 51d. The fourth connection protruding portion 74 is arranged at a position which is closer to the other end side with respect to the seventh connection protruding portion 83, on the first inner surface 51a. The eighth connection protruding portion 84 is arranged at a position which is closer to the other end side with respect to the fourth connection protruding portion 74, on the fourth inner surface 51d. It is to be noted that, in FIG. 12, protruding end portions 54b which are scraped in the first to eighth connection protruding portions 71 to 74 and 81 to 84 are indicated by dashed line of one long dash and two short dashes.

Intervals L2, L3, and L4 of the first to fourth connection protruding portions 71 to 74 are equal to each other. Intervals L5, L6, and L7 of the fifth to eighth connection protruding portions 81 to 84 are equal to each other. Additionally, the intervals L2 to L4 are equal to the intervals L5 to L7. Further, an interval L8 between the first and fifth connection protruding portions 71 and 81, an interval L9 between the fifth and second connection protruding portions 81 and 72, an interval L10 between the second and sixth connection protruding portions 72 and 82, an interval L11 between the sixth and third connection protruding portions 82 and 73, an interval L12 between the third and seventh connection protruding portions 73 and 83, an interval L13 between the seventh and fourth connection protruding portions 83 and 74, and an interval L14 between the fourth and eighth connection protruding portions 74 and 84 along the depth direction C are equal to each other. Therefore, positions of the fifth to eighth connection protruding portions 81 to 84 with respect to the fourth inner surface 51d are equal to positions of the first to fourth connection protruding portions 71 to 74 with respect to the first inner surface 51a.

In other words, even if the accommodating portion 46 is rotated 180 degrees on a center line P1, i.e., even if the accommodating portion 46 shown in FIG. 12 is rotated 180 degrees on the center line P1, a cross-sectional shape of the accommodating portion 46 is the same before and after the rotation.

Even this embodiment can obtain the same functions and effects as those of the first embodiment. Furthermore, since the connection protruding portions 54 are alternately arranged on the first and fourth inner surfaces 51a and 51d, which face each other, along the depth direction C at equal intervals, these members hold the fitting protruding portion 33 in a well-balanced manner, and hence electrical connection between the fitting protruding portion 33 and the accommodating portion 46 can be improved.

In this embodiment, the first to fourth connection protruding portions 71 to 74 are formed on the first inner surface 51a, and the fifth to eighth connection protruding portions 81 to 84 are formed on the second inner surface 51b. Furthermore, these members are alternately arranged at equal intervals. As another example, the connection protruding portions whose number is not four may be formed on each of the first and fourth inner surfaces 51a and 51d and, for example, three or five connection protruding portions may be formed on each inner surface. In this case, the connection protruding portions are alternately arranged.

In this manner, the connection protruding portions are alternately arranged on surfaces facing each other, e.g., the first and fourth inner surfaces 51a and 51d in this embodiment, the connection protruding portions formed on one surface are apart from each other at equal intervals, and the connection protruding portions formed on the other surface are apart from each other at equal intervals, whereby the connection protruding portions 54 can hold the fitting protruding portion 33 in a well-balanced manner. Moreover, a distance between one connection protruding portion formed on the one surface and one connection protruding portion formed on the other surface which are adjacent to each other is the same, and hence the fitting protruding portion 33 can be held by the connection protruding portions in a further well-balanced manner.

An assembled battery according to a fourth embodiment will now be described with reference to FIGS. 13 to 16. It is to be noted that reference numerals equal to those in the first embodiment denote structures having the same functions as those in the first embodiment, and a description thereof will be omitted.

FIG. 13 is a perspective view showing a fitting protruding portion 33 according to this embodiment. As shown in FIG. 13, in this embodiment, connection protruding portions 54 are formed on the fitting protruding portion 33. The connection protruding portions 54 are not formed on an accommodating portion 46. Additionally, the connection protruding portions 54 are made of a material softer than that of the accommodating portion 46. In this embodiment, for example, each electrode terminal 31 according to this embodiment is made of a material that forms the accommodating portion 46 in the first embodiment, and each bus bar 40 and each terminal bus bar 60 of each accommodating portion 46 according to this embodiment are made of a material that forms the electrode terminals 31 in the first embodiment. Therefore, the connection protruding portions 54 are softer than the accommodating portions 46. In other words, the connection protruding portions 54 are readily scraped.

For example, the two connection protruding portions 54 are formed on each of first and fourth peripheral surfaces 35a and 35d. In FIG. 13, the connection protruding portions 54 formed on the fourth peripheral surface 35d are shown. A positional relationship of the connection protruding portions 54 with respect to the first peripheral surface 35a is the same as a positional relationship of the connection protruding portions 54 with respect to the fourth peripheral surface 35d.

One of the two connection protruding portions 54 formed on the first peripheral surface 35a is arranged on the second peripheral surface 35b side, and the other is arranged on the third peripheral surface 35c side. One of the two connection protruding portions 54 formed on the fourth peripheral surface 35d is arranged on the second peripheral surface 35b side, and the other is arranged on the third peripheral surface 35c side. The one of the two connection protruding portions 54 formed on the first peripheral surface 35a faces the one of the two connection protruding portions 54 formed on the fourth peripheral surface 35d along a width direction B. The other connection protruding portion 54 formed on the first peripheral surface 35a faces the other connection protruding portion 54 formed on the fourth peripheral surface 35 along the width direction B.

Furthermore, distances from the second peripheral surface 35b to the connection protruding portions 54 arranged on the second peripheral surface 35b side of the first and fourth peripheral surfaces 35a and 35d are equal to each other. Distances from the third peripheral surface 35c to the connection protruding portions 54 arranged on the third peripheral surface 35c side of the first and fourth peripheral surfaces 35a and 35d are equal to each other. Moreover, the distances from the second peripheral surface 35b to the connection protruding portions 54 arranged on the second peripheral surface 35b side of the first and fourth peripheral surfaces 35a and 35d are equal to the distances from the third peripheral surface 35c to the connection protruding portions 54 arranged on the third peripheral surface 35c side of the first and fourth peripheral surfaces 35a and 35d.

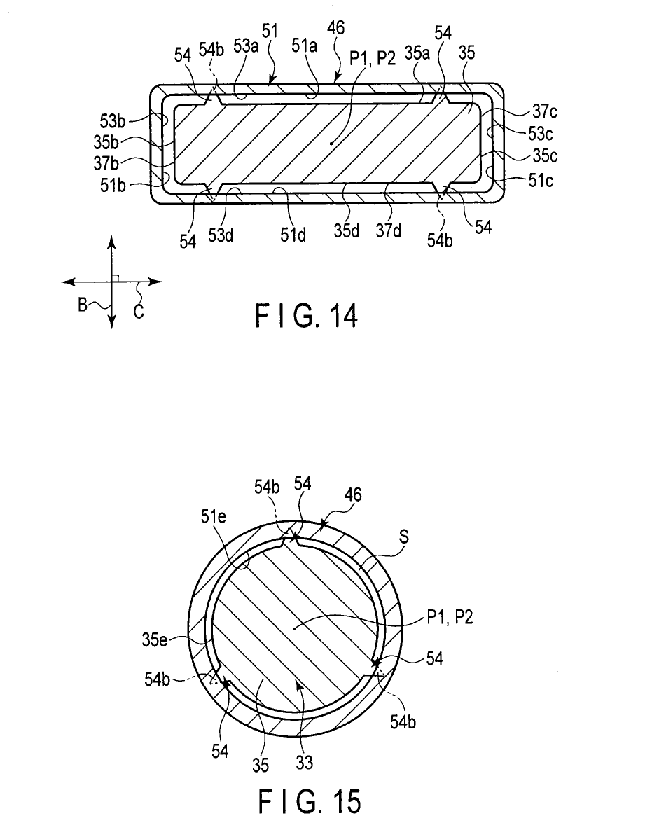

FIG. 14 is a cross-sectional view, which shows a state that the fitting protruding portion 33 is accommodated in the accommodating portion 46, taken along a direction vertical to a protruding direction A. FIG. 14 shows a cut state like FIG. 5. In FIG. 14, protruding end portions 54b of the connection protruding portions 54 which are cut when accommodated in the accommodating portion 46 are indicated by a dashed line of one long dash and two short dashes.

As shown in FIG. 14, each connection protruding portion 54 has a size that allows its protruding end portion 54b to be placed in a peripheral wall portion 51 of the accommodating portion 46 before being accommodated in the accommodating portion 46. Therefore, when the fitting protruding portion 33 is inserted into the accommodating portion 46, each connection protruding portion 54 is scraped by the inner surface of the accommodating portion 46, and the inner surface of the accommodating portion 46 is also scraped. Therefore, electrical connection between each electrode terminal 31 and each bus bar 40 and electrical connection between each electrode terminal 31 and each terminal bus bar 60 can be improved.

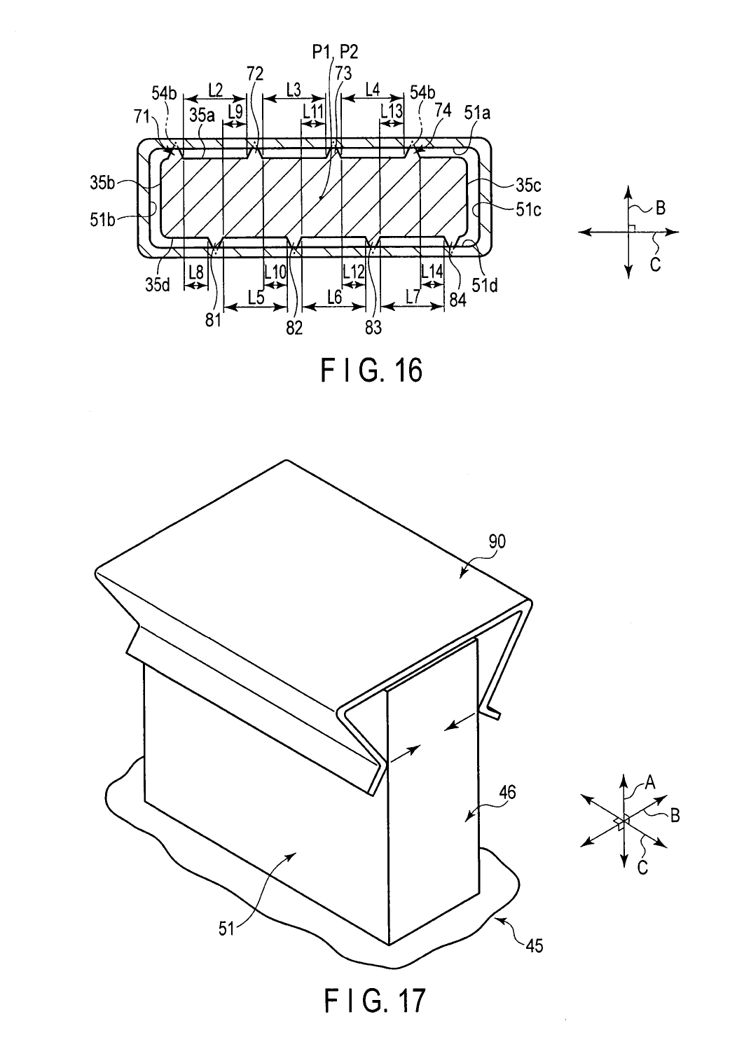

It is to be noted that, in the second and third embodiments, like this embodiment, the connection protruding portions 54 formed in the accommodating portion 46 may be formed on the fitting protruding portion. Each of FIGS. 15 and 16 is a cross sectional view, which shows a state that the connection protruding portions 54 are formed on the fitting protruding portion 33 like this embodiment and the fitting protruding portion 33 is accommodated in the accommodating portion 46, taken along a direction vertical to the protruding direction A.

FIG. 15 shows a cut state like FIG. 11. In FIG. 15, the connection protruding portions 54 are arranged at equal intervals around a center line P2 of the fitting protruding portion 33. In other words, they are arranged at intervals of the same angle. For example, the connection protruding portions 54 are arranged at intervals of 120 degrees. In the drawing, each protruding end portion 54b to be scraped is indicated by a dashed line of one long dash and two short dashes. Even in the configuration shown in FIG. 15, electrical connection between each electrode terminal 31 and each bus bar 40 and electrical connection between each electrode terminal 31 and each terminal bus bar 60 can be improved.

FIG. 16 shows a cut state like FIG. 12. In FIG. 16, intervals L2 to L13 set to the first to eighth connection protruding portions 71 to 74 and 81 to 84 are equal to those explained in the second embodiment. Even the configuration shown in FIG. 16 can provide excellent electrical connection between each electrode terminal 31 and each bus bar 40 and excellent electrical connection between each electrode terminal 31 and each terminal bus bar 60.

An assembled battery according to a fifth embodiment will now be described with reference to FIG. 17. It is to be noted that structures having the same functions as those in the first embodiment are denoted by the same reference numerals as those in the first embodiment, thereby omitting a description thereof. This embodiment is different from the first embodiment in that the assembled battery further comprises clips. Other points are equal to the first embodiment. The different points will be specifically described.

FIG. 17 is an enlarged perspective view showing an accommodating portion 46 having a fitting protruding portion 33 accommodated therein in a bus bar 40 or a terminal bus bar 60 according to this embodiment. As shown in FIG. 17, in this embodiment, the assembled battery 10 further comprises clips 90. Each clip 90 clips the accommodating portion 46 in a state that the fitting protruding portion 33 is accommodated in the accommodating portion 46.

The clip 90 clips a peripheral wall portion 51 of the accommodating portion 46 in a width direction B. As a result, the clip 90 presses connection protruding portions 54 toward first and fourth peripheral surfaces 35a and 35d. Therefore, electrical connection between each electrode terminal 31 and each bus bar 40 and electrical connection between each electrode terminal 31 and each terminal bus bar 60 can be improved.

It is to be noted that, in the third and fourth embodiments, the clips 90 according to this embodiment may be likewise used. In this case, electrical connection between each electrode terminal 31 and each bus bar 40 and electrical connection between each electrode terminal 31 and each terminal bus bar 60 can be further improved.

It is to be noted that, in the first to fourth embodiments, the electrode terminal 31 of one electric cell 30 is an example of a connection target connected to the electrode terminal 31 of another electric cell 30 by the bus bar 40. Further, each of the external connection terminals 11 and 12 is an example of a connection target connected to the electrode terminal 31 by the terminal bus bar 60.

It is to be noted that each of the cross-sectional shape of the fitting protruding portion 33 vertical to the protruding direction A and the shape of the cross section of the accommodating portion 46, which is formed by the first to fourth inner surfaces 51a to 51d, vertical to the protruding direction A is rectangular. As another example, an elliptic shape may be adopted. As described above, the cross-sectional shape of the fitting protruding portion 33 vertical to the protruding direction A and the cross-sectional shape of the accommodating portion 46 vertical to the protruding direction may be other than the rectangular shape. The second embodiment provides such an example.

The present invention is not restricted to the foregoing embodiments as it is, and constituent elements can be modified in an implementation phase without departing from the gist to embody the present invention. Additionally, various inventions can be constituted by appropriately combining the constituent elements disclosed in the foregoing embodiments. For example, some of all the constituent elements disclosed in the foregoing embodiments may be eliminated. Further, configurations of different embodiments may be combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An assembled battery comprising:
electric cells each having a protruding electrode terminal;
a bus bar which is connected to the electrode terminal, also electrically connected to the electrode terminal, and comprises an accommodating portion that has an opening and accommodates the electrode terminal along a protruding direction of the electrode terminal from the opening; and
a protruding portion which is formed on one of a peripheral surface of the electrode terminal along the protruding direction and an inner surface of the accommodating portion along the protruding direction, protrudes toward the other of the peripheral surface and the inner surface, extends in the protruding direction, and comes into contact with the other.

2. The assembled battery according to claim 1,
wherein, in the case of forming the protruding portion on the inner surface, before accommodating the electrode terminal in the accommodating portion, a cross section of the accommodating portion including the protruding portion vertical to the protruding direction has a size that allows a protruding end portion of the protruding portion to be placed on the inner side beyond the peripheral surface, and
in the case of forming the protruding portion on the peripheral surface, before the electrode terminal is accommodated in the accommodating portion, the cross section of the electrode terminal including the protruding portion vertical to the protruding direction has a size that allows the protruding end portion to be placed on the outer side beyond the inner surface.

3. The assembled battery according to claim 2,
wherein, at a time of accommodating the electrode terminal in the accommodating portion, the protruding end portion of the protruding portion is rubbed against the other of the inner surface and the peripheral surface and scraped.

4. The assembled battery according to claim 1,
wherein the accommodating portion comprises: a peripheral wall portion which has the inner surface; and an end wall portion which is coupled with an end of the peripheral wall portion and covers the end.

5. The assembled battery according to claim 1,
wherein the protruding portions are provided and arranged around the electrode terminal at equal intervals.

6. The assembled battery according to claim 1,
wherein a cross section of the electrode terminal vertical to the protruding direction has a pair of edges that face each other, and
the protruding portions are alternately formed along the pair of edges on one side and the other side of the pair of edges.

7. The assembled battery according to claim 6,
wherein the protruding portion formed on the one side and the protruding portion formed on the other side are distanced at equal intervals in a extending direction of the edges.

8. The assembled battery according to claim 1, comprising a clip which clips the accommodating portion from the outer side toward the inner side in a state that the electrode terminal is accommodated in the accommodating portion.

9. The assembled battery according to claim 8,
wherein the clip clips a part of the accommodating portion which faces the protruding portion.

10. The assembled battery according to claim 1,
wherein the protruding portion is formed in the accommodating portion.
